(19) United States
(12) Patent Application Publication
(10) Pub. No.: US 2025/0008577 A1
(43) Pub. Date: Jan. 2, 2025

(54) SESSION INFORMATION SUBSCRIPTION METHOD AND APPARATUS, AND DEVICE

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventors: Xu CHEN, Beijing (CN); Dan WANG, Beijing (CN)

(21) Appl. No.: 18/703,415

(22) PCT Filed: Oct. 24, 2022
(86) PCT No.: PCT/CN2022/127112

§ 371 Date: Apr. 22, 2024

(30) Foreign Application Priority Data
Oct. 22, 2021 (CN) 202111234256.5
Mar. 9, 2022 (CN) 202210226031.3

(51) Int. Cl. H04W 76/10; H04W 4/60

(52) U.S. Cl. CPC H04W 76/10; H04W 4/60

(57) ABSTRACT

The present application provides a session information subscription method and apparatus, and a device. The method, which is on an application function or capability exposure function side, comprises: subscribing to session information from a first network function; and receiving a notification for the subscription, and determining a policy control function (PCF). The solution of the present application solves the problem of PCF addressing in an Ethernet PDU session binding scenario.

### CROSS-REFERENCE TO RELATED APPLICATIONS

This application is based on and claims priority from Chinese patent No. 202111234256.5 filed on Oct. 22, 2021 and Chinese patent No. 202210226031.3 filed on Mar. 9, 2022, the contents of which are hereby incorporated by reference in their entireties.

### TECHNICAL FIELD

The present disclosure relates to the technical field of communications, and in particular, to a method, apparatus, and a device for subscribing session information.

### BACKGROUND

A Policy Control and Charging (PCC) architecture is illustrated in FIG. 1. The architecture requires N7 (Session Management Function (SMF)-Policy Control Function (PCF)) messages and N5/Rx interface (Application Function (AF)-PCF) messages of a same user to be addressed to a same PCF, to realize unique association between a service data flow of the user and a specific Quality of Service (QoS) flow.

When multiple individually addressable PCFs are deployed in a network, a Binding Support Function (BSF) implements a Fifth Generation (5G) user Protocol Data Unit (PDU) session binding function.

The BSF stores session binding information for each PDU session, such as a user identifier, a data network name (DNN), user equipment (UE) address (such as an Internet Protocol (IP) address or a Media Access Control (MAC) address), and the address of a PCF selected by the SMF, to ensure that when the AF recognizes a service transmission policy of the UE based on the address of the UE, a PCF address query service is provided for the AF and a Network Exposure Function (NEF), so as to realize that the N5/Rx interface is addressed to the PCF corresponding to the PDU session of the service of the UE.

A 5G network contains different types of PUD sessions: IPv4, IPv6, IPv4v6, Ethernet and Unstructured. Non-IP PDU sessions (for example, a Ethernet PDU session) are oriented at vertical industrial user/Internet of Things (IoT) applications. Different from users of large networks, the vertical industrial users have no roaming property, and there is no demand for acquiring a mobile IP address to ensure connectivity of an Internet application when the users access a data network. The PCC policy control is implemented only within a local area network, and the UE accesses a service application platform using the MAC address. The MAC address is not allocated by the 5G network, but is held by the terminal itself and is brought to the network when accessing the network.

When there are multiple BSFs in the 5G network, it is difficult to plan an MAC address range served by a BSF in advance, and there is difficulty for the BSF to acquire the PCF address by addressing according to the MAC address of the UE; and there is no solution to this at present.

### SUMMARY

The technical problem to be solved by the present disclosure is how to provide a method and apparatus for subscribing session information, and a device, to solve a PCF addressing problem in an Ethernet PDU session binding scenario.

To solve the above technical problem, the present disclosure provides the following technical solution.

There is provided a method for subscribing session information, applied to an application function (AF) or a network exposure function (NEF), and including: subscribing the session information from a first network function; and receiving a notification for the subscription and determining a policy control function (PCF), wherein the notification includes the session information.

Optionally, the session information is binding information of a session, and includes: a user identifier or a user address; a PCF address or a PCF identifier; a data network name (DNN); and/or a slice identifier.

Optionally, the subscription includes a user identifier or a user address, and the subscription is associated with a session of the user identifier or the user address.

Optionally, the subscription is used for subscribing a situation of: binding information of a session associated with the subscription is created, modified or updated; or the session associated with the subscription is established, or a user address associated with the session is changed, or a user address is added to the session; or a user address is deleted from the session.

Optionally, the session information included in the notification is a user address associated with a session.

Optionally, subscribing the session information from the first network function includes subscribing at least one event of: the user address associated with the session changes; a user address is added to the session; or a user address is deleted from the session.

Optionally, the session is an Internet protocol (IP) data unit (PDU) session or an Ethernet PDU session, and the user address includes an IP address or a media access control (MAC) address.

Optionally, the subscription further includes at least one of: a data network name (DNN), a slice identifier, or a PDU session type.

Optionally, receiving the notification for the subscription to determine the PCF further includes: receiving the notification for the subscription and according to the notification, obtaining at least one of: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address, wherein the binding information of the session further contains a user address associated with the session corresponding to the user identifier or the user address; and determining the PCF according to the user address associated with the session and the binding information of the session, or querying the first network function to determine the PCF according to the user address associated with the session and the identifier or the address of the first network function.

Optionally, receiving the notification for the subscription to determine the PCF further includes: receiving the notification for the subscription and according to the notification, further obtaining at least one of: a correspondence relationship between: a user identifier or a user address and an identifier or an address of the first network function which creates binding information of a session of a user; or determining the first network function according to the correspondence relationship; and querying the first network function to determine the PCF according to the binding information of the session and a user address associated with the session.

Optionally, the user address is at least one of: a user MAC address; a user IP address; or a user address associated with a session corresponding to the subscription.

Optionally, receiving the notification for the subscription to determine the PCF includes: receiving the notification for the subscription and obtaining the user address associated with the session according to the notification; and determining the PCF according to the session corresponding to the user address.

Optionally, an identifier or address of the PCF is from one of: a notification for a subscription associated with the session corresponding to the user address; query of information associated with the session corresponding to the user address; storage of the information associated with the session corresponding to the user address; or a configuration of the information associated with the session corresponding to the user address.

Optionally, binding information of a session is created by the first network function, and the PCF indicates, according to a configuration or use subscription data, whether to create the binding information of the session.

Optionally, the PCF indicates, based on at least one of the DNN or slice granularity, whether to create the binding information of the session.

Optionally, the PCF requires a session management function (SMF) to report a user address of a session associated with a DNN and/or a slice, and the binding information of the session contains one or more user addresses associated with the session.

Optionally, the user address includes one of: a user address carried by user equipment (UE) in a session establishment request or a session modification request of a PDU session; a user address reported by a user plane function (UPF) after the UPF detects a data packet according to a rule, which is issued by the SMF for the PDU session; or a user address returned by a data network authentication, authorization, accounting (DN-AAA) during authentication of the PDU session; wherein the user address is an IP address or an MAC address.

Optionally, the PCF creates or updates the binding information of the session for the first network function after receiving a user address associated with a PDU session that is reported by the SMF; or the SMF creates or updates the binding information of the session for the first network function.

Optionally, before subscribing the session information from the first network function, the method further includes: acquiring an address or address list of a user, wherein the address or address list of the user belongs to at least one of: a predetermined slice, a predetermined DNN, or a predetermined session type.

An embodiment of the present disclosure further provide a method for subscribing session information, applied to a first network function, and including: receiving, from an application function (AF) or a network exposure function (NEF), subscription for the session information; and sending a notification for the subscription to the AF or the NEF, wherein the notification includes the session information.

Optionally, the session information is binding information of a session, and includes: a user identifier or a user address; a PCF address or a PCF identifier; a data network name (DNN); and/or a slice identifier.

Optionally, the subscription includes a user identifier or a user address, and the subscription is associated with a session of the user identifier or the user address.

Optionally, the subscription is used for subscribing a situation of: binding information of a session associated with the subscription is created, modified or updated; or the session associated with the subscription is established, or a user address associated with the session is changed, or a user address is added to the session; or a user address is deleted from the session.

Optionally, the session information included in the notification is a user address associated with a session.

Optionally, receiving, from the AF or the NEF, the subscription for the session information includes subscription for at least one event of: the user address associated with the session changes; a user address is added to the session; or a user address is deleted from the session.

Optionally, the session is an Internet protocol (IP) data unit (PDU) session or an Ethernet PDU session, and the user address includes an IP address or a media access control (MAC) address.

Optionally, the subscription further carries a data network name (DNN), a slice identifier, or a PDU session type.

Optionally, the notification for the subscription includes at least one of: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address, wherein the binding information of the session further contains a user address associated with the session corresponding to the user identifier or the user address.

Optionally, the user address is at least one of: a user MAC address; a user IP address; or a user address associated with a session corresponding to the subscription.

An embodiment of the present disclosure further provides an apparatus for subscribing session information, applied to an application function (AF) or a network exposure function (NEF), and including: a transceiving module, configured to: subscribe the session information from a first network function; and receive a notification for the subscription to determine a policy control function (PCF), wherein the notification includes the session information.

An embodiment of the present disclosure further provides an application function (AF) or a network exposure function (NEF), including the apparatus for subscribing session information of claim 30.

An embodiment of the present disclosure further provides an apparatus for subscribing session information, applied to a first network function, and including: a transceiving module, configured to: receive subscription for the session information from an application function (AF) or a network exposure function (NEF), and send a notification for the subscription to the AF or the NEF, wherein the notification includes the session information.

An embodiment of the present disclosure further provides a first network function entity, including the above-described apparatus for subscribing session information.

An embodiment of the present disclosure further provides a communication device, including a processor, and a memory having stored thereon a computer program that, when run by the processor, implements the above-described methods.

An embodiment of the present disclosure further provides a computer-readable storage medium having stored thereon instructions that, when run on a computer, enable the computer to perform the above-described methods.

The above solutions of the present disclosure have at least the following beneficial effects:

By subscribing for the first session information from a first network function, and receiving a notification for the subscription and determining a policy control function (PCF), the notification including the session information, the PCF addressing of an Ethernet PDU session binding scenario can be realized.

### BRIEF DESCRIPTION OF THE DRAWINGS

FIG. 1 illustrates a schematic diagram of service interfaces of a session binding functional network element and other functional network elements.

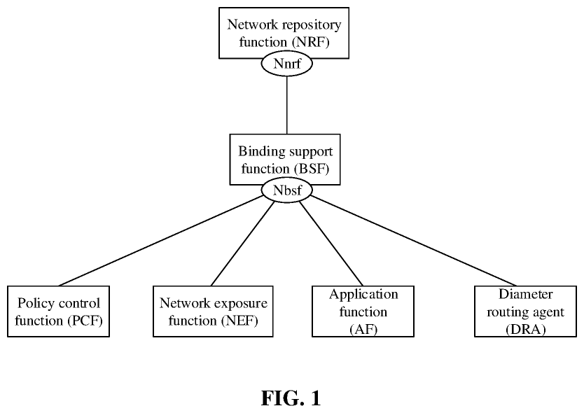

FIG. 2 illustrates a schematic flowchart of a method for subscribing session information according to an embodiment of the present disclosure.

FIG. 3 illustrates a schematic flowchart of a method for subscribing session information in an independent BSF scenario according to an embodiment of the present disclosure.

FIG. 4 illustrates a schematic flowchart of a method for subscribing session information in a non-independent BSF scenario according to an embodiment of the present disclosure.

FIG. 5 illustrates another schematic flowchart of a method for subscribing session information according to an embodiment of the present disclosure.

FIG. 6 illustrates yet another schematic flowchart of a method for subscribing session information according to an embodiment of the present disclosure.

FIG. 7 illustrates a schematic block diagram of an apparatus for subscribing session information according to an embodiment of the present disclosure.

### DETAILED DESCRIPTION

Exemplary embodiments of the present disclosure will be described in more detail with reference to the accompanying drawings. Though exemplary embodiments of the present disclosure are illustrated in the accompanying drawings, it should be understood that the present disclosure may be implemented in various forms without being limited by the embodiments described herein. On the contrary, these embodiments are provided to help understanding the present disclosure more thoroughly, and convey the scope of the present disclosure to those skilled in the art more completely.

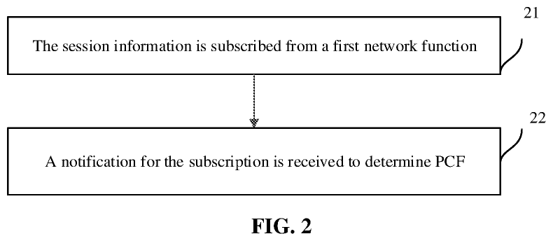

As illustrated in FIG. 2, an embodiment of the present disclosure provides a method for subscribing session information, applied to an application function (AF) or a network exposure function (NEF). The method includes following operations.

At 21, the session information is subscribed from a first network function.

Here, the AF or the NEF may send a subscription request message to the first network function, to subscribe the session information.

At 22, a notification for the subscription is received, and a policy control function (PCF) is determined. The notification includes the session information.

Here, after the AF or the NEF subscribes the session information from the first network function, the first network function may send a notification message for the subscription to the AF or the NEF. The AF or the NEF receives the notification message, and obtains the session information included in the notification message.

In the embodiment, the session information is subscribed from the first network function, a notification for the subscription is received and the PCF is determined, and the notification includes the session information, such that PCF addressing in an Ethernet protocol data unit (PDU) session binding scenario is realized.

Here, the session information is binding information associated with a session, and includes: a user identifier or a user address; a PCF address or a PCF identifier; a data network name (DNN); and/or a slice identifier.

The subscription includes a user identifier or a user address, and the subscription is associated with a session of the user identifier or the user address.

In an optional embodiment of the present disclosure, the subscription is used for subscribing a situation of: binding information of a session associated with the subscription is created, modified or updated; or the session associated with the subscription is established, or a user address associated with the session is changed, or a user address is added to the session; or a user address is deleted from the session.

The session is an Internet protocol (IP) data unit (PDU) session or an Ethernet PDU session, and the user address includes an IP address or a media access control (MAC) address.

The subscription further includes at least one of: a data network name (DNN), a slice identifier, or a PDU session type.

Here, the AF having a PCF service call request acquires, by a configuration or by querying a DN-AAA, an authorized customer premises equipment (CPE) ID/address list in a responsible slice and the DNN. The AF initiates subscription to a service specified slice and the first network function (such as a BSF) in the DNN through the NEF. Subscription manner 1): the session information is subscribed by slice ID and authorized CPE ID/address list in the DNN. Subscription manner 2): MAC address update in the session information is subscribed by the slice ID, the DNN and a PDU session type (Ethernet PDU session).

In an optional embodiment of the present disclosure, in the above method for subscribing the session information, the operation that the notification for the subscription is received and the PCF is determined may further includes following operations.

The notification for the subscription is received, and according to the notification, at least one of following is obtained: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address.

The binding information of the session further contains a user address associated with the session corresponding to the user identifier or the user address.

The PCF is determined according to the user address associated with the session and the binding information of the session, or the first network function is queried to determine the PCF according to the user address associated with the session and the identifier or the address of the first network function.

In an optional embodiment of the present disclosure, in the above method for subscribing the session information, the operation that the notification for the subscription is received and the PCF is determined further includes following operations.

The notification for the subscription is received and at least one of following is further obtained according to the notification: a correspondence relationship between a user identifier or a user address and an identifier or an address of the first network function which creates binding information of a session of a user; the first network function is determined according to the correspondence.

The first network function is queried to determine the PCF according to the binding information of the session and a user address associated with the session.

Further, a record may also be generated according to the notification and/or an existing record may be updated and deleted according to the notification.

In an optional embodiment of the present disclosure, the session information included in the notification in the above operation 22 is a user address associated with a session. In particular, the user address is at least one of:
1) a user MAC address;
2) a user IP address; or
3) a user address associated with a session corresponding to the subscription.

In the above operation 22, subscribing the session information from the first network function may particularly include subscribing at least one event of:
the user address associated with the session changes;
a user address is added to the session; or
a user address is deleted from the session.

For example, when subscription is made for an event that the user address associated with the session changes, that a user address is added to the session, or that a user address is deleted from the session, the notification for the subscription may include the user address associated with the session.

At 22, the operation that the notification for the subscription is received and the PCF is determined may particularly include following. The notification for the subscription is received and the user address associated with the session is obtained according to the notification. The PCF is determined according to the session corresponding to the user address.

Particularly, the session corresponding to the user address may be determined according to the user address, so as to determine the PCF associated with the session corresponding to the user address.

For example, the notification for the subscription includes a first user address associated with a first session. In this case, at the operation 22, the first session corresponding to the first user address may be determined according to the first user address, and then an identifier or address of a first PCF associated with the first session is determined according to an association relationship between user addresses and identifiers or addresses of PCFs.

Additionally, an identifier or address of the PCF may be from one of:
1) a notification for a subscription associated with the session corresponding to the user address;
2) query of information associated with the session corresponding to the user address;
3) storage of the information associated with the session corresponding to the user address; or
4) a configuration of the information associated with the session corresponding to the user address.

Here, in the above item 1), the related subscription refers to subscription for related events of the session corresponding to the user address. In the above items 2)-4), the information associated with the session corresponding to the user address may particularly include one or more of following information: a user identifier or a user address; a PCF address or a PCF identifier; a DNN; or a slice identifier.

In an optional embodiment of the present disclosure, binding information of a session is created by the first network function, and the PCF indicates, according to a configuration or use subscription data, whether to create the binding information of the session.

Optionally, the PCF indicates, based on at least one of the DNN or slice granularity, whether to create the binding information of the session.

The PCF requires a session management function (SMF) to report a user address of a session associated with a DNN and/or a slice, and the binding information of the session contains one or more user addresses associated with the session.

The process of creating the session information includes following.

An MAC address associated with the PDU session is acquired through the SMF.

The session information is updated in a session context of a user by the SMF, and whether the PCF has made the subscription is checked. If yes, the MAC address associated with the PDU session is reported to the PCF.

In particular, the subscribed slice, the DNN and the authorization rule are checked; and after the check is passed, the CPE ID/address subscription list is recorded by distinguishing the slice from the DNN. Alternatively, the subscribed slice, the DNN and the authorization rule are checked; and after the check is passed, a subscribed event is recorded by distinguishing the slice from the DNN. The subscribed event is update of an MAC address of the PDU session.

A receiving PCF confirms, based on a configuration or a user subscription, that there is a session binding demand. The PCF is selected to be associated with session management when the SMF triggers, based on the CPE, Ethernet PDU session establishment for a specified slice/DNN.

In the embodiment, the first network function (such as a BSF) checks the subscribed slice, the DNN and the authorization rule, and records, after the check is passed, the CPE ID/address subscription list (including an identifier/ID of the AF initiating the subscription, and the subscribed slice/DNN/CPE information list) by distinguishing the slice from the DNN. The first network function checks the subscribed slice, the DNN and the authorization rule, and records, after the check is passed, a subscribed event (update of an MAC address of the Ethernet PDU session) by distinguishing the slice from the DNN.

When the CPE triggers establishment of a Non-IP PDU session (including an Ethernet PDU session) of a specified slice/DNN, the SMF receives a session establishment request, and selects a policy control function (PCF) associated with session management. The PCF confirms, based on a configuration or a user subscription, whether there is a session binding demand, namely whether the AF has an N5 interface service call demand. The configuration and the user subscription may be based on the DNN and/or a slice granularity.

In an optional embodiment of the present disclosure, the user address include one of: a user address carried by user equipment (UE) in a session establishment request or a session modification request of a PDU session; a user address reported by a user plane function (UPF) after the UPF detects a data packet according to a rule issued by the SMF for the PDU session; or a user address reported by a DN-AAA during authentication of the PDU session.

The user address is an IP address or an MAC address.

In the above embodiments of the present disclosure, the PCF creates or updates the binding information of the session for the first network function after receiving a user address associated with a PDU session that is reported by the SMF; or the SMF creates or updates the binding information of the session for the first network function.

In an optional embodiment of the present disclosure, in the above method for subscribing the session information, before subscribing the session information from the first network function, the method further includes following operation.

An address or address list of a user is acquired. The address or address list of the user belongs to at least one of: a predetermined slice, a predetermined DNN, or a predetermined session type. Here, the address or address list of the user may be acquired through a configuration or by querying a DN-AAA.

In the embodiment, only if there is a session binding demand, the first network function (such as the BSF) will create session information. The particular process of creating the session information is as follows:
(1) the PCF requires the SMF to report an MAC address associated with the Ethernet PDU session.
(2) The SMF acquires the MAC address, in a particular way including:
(21) an MAC address carried in a PDU session establishment request or a PDU session modification request by user equipment (UE);
(22) an MAC address reported by a user plane function (UPF) after the UPF performs source MAC address detection on a user-plane/media-plane data packet according to a detection rule issued by the SMF for the session;
(23) when a DNN associated with the PDU session needs data network (DN) authentication, the SMF initiates an authentication request to the data network authentication, authorization, accounting (DN-AAA); and after the authentication is passed, the DN-AAA returns authorization for use of a group of MAC addresses of the PDU session.
(3) After acquiring the MAC addresses associated with the PDU session, the SMF updates the session information in a session context of a user, checks whether the PCF has made the subscription, and reports the MAC address associated with the PDU session to the PCF, if yes. If the MAC address is acquired in the way of being carried in the PDU session modification request message by the UE or being detected by the UPF, the MAC address may be reported for multiple times.
(4) In the scenario of an independent BSF, the PCF receives the reported MAC addresses and creates the session information to the BSF; and in a scenario of the SMF being deployed together with the BSF, the SMF creates the session information to the PCF or directly to the BSF.

In the above embodiments of the present disclosure, the method further includes: the BSF bound to the session selected during establishment of the Ethernet PDU session creates session information; then the BSF informs, according to the subscription request, the AF of the slice/DNN/PCF address corresponding to the session created by the CPE matching the subscribed CPE ID/address.

Subsequently, the AF acquires the CPE and the MAC address of a device connected to the CPE in the following way:

the BSF informs the AF if the binding information of the session of the CPE changes (the MAC address of the device after the CPE is added). The AF stores a correspondence relationship between the CPE and the MAC address of the device after the CPE is added.

User-plane management is performed for the session between the AF and the UPF. For example the session is identified by a tunnel. When the session is identified, the UPF should confirm the MAC address of the CPE with the AF. When the source address received by the AF from the corresponding session is another MAC address, the AF should store the correspondence relationship between the CPE and the MAC address of the device after the CPE is added.

When the source MAC address is received from a user plane/media plane, and subscription to the PCF needs to be initiated, the AF determines the PCF address according to the correspondence relationship between the CPE ID/address and the PCF address, the CPE and the MAC address of the device connected to the CPE. Thus, a PCF addressing problem in an Ethernet PDU session binding scenario is solved.

The above embodiment is not limited to the case where the address of the device connected to the CPE is an MAC address, but is also applicable to the case where the address of the device is an IP address.

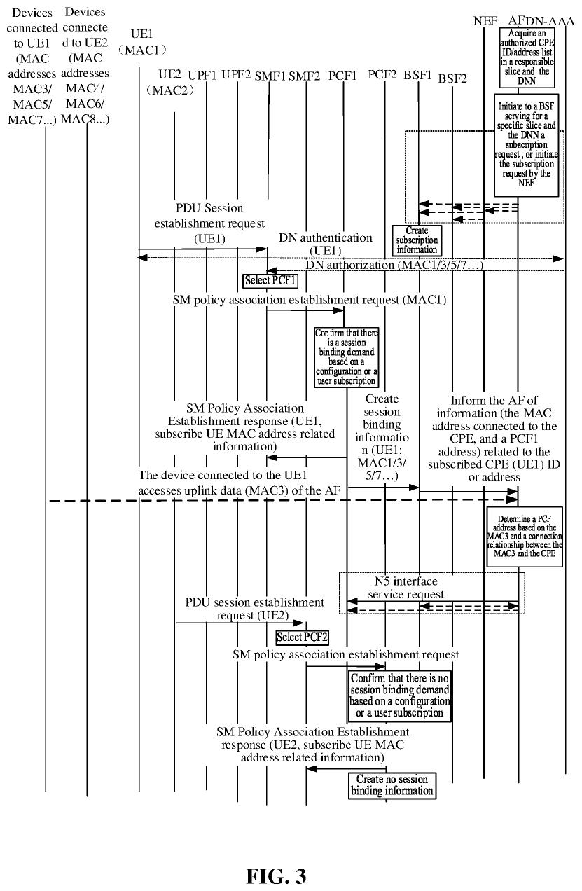

In an implementation example of the present disclosure, as illustrated in FIG. 3, in the scenario of an independent BSF, the procedure of obtaining the MAC address of the device connected to the UE through authorization of the DN-AAA includes following.

The AF acquires, from the DN-AAA, an authorized CPE ID/address list in a responsible slice and the DNN.

The AF initiates to a BSF (including a BSF1 and a BSF2) serving for a specific slice and the DNN a subscription request (carrying the slice, the DNN, the CPE ID or the address list). The subscription request may also be initiated to the BSF (including the BSF1 and the BSF2) by the NEF.

UE1 initiates a PDU Session establishment request to an SMF1.

UE1 performs DN authentication with the DN-AAA.

The DN-AAA performs authorization.

The SMF1 sends an SM Policy Association Establishment request to a PCF1.

The PCF1 confirms that there is a session binding demand based on a configuration or a user subscription.

The PCF1 sends an SM Policy Association Establishment response to the SMF1.

The PCF1 creates session information to the BSF1.

The BSF1 informs the AF of information (the MAC address connected to the CPE, and a PCF1 address) associated with the subscribed CPE (UE1) ID or address.

The AF accepts the device connected to the UE1 to access uplink data (MAC3) of the AF.

The AF determines a PCF address based on the MAC3 and a connection relationship between the MAC3 and the CPE.

UE2 initiates PDU Session establishment to an SMF2.

The SMF2 sends an SM Policy Association Establishment request to a PCF2.

The PCF2 confirms, based on a configuration or a user subscription, that there is no session binding demand.

The PCF2 sends an SM Policy Association Establishment response to the SMF2.

The UE2 does not subscribe UE MAC address related information.

The embodiment of the present disclosure provides the capability that the AF affects user-plane flow route for the Ethernet PDU session, and can solve the PCF addressing in the Ethernet PDU session binding scenario for the scenario where UE is connected to multiple devices.

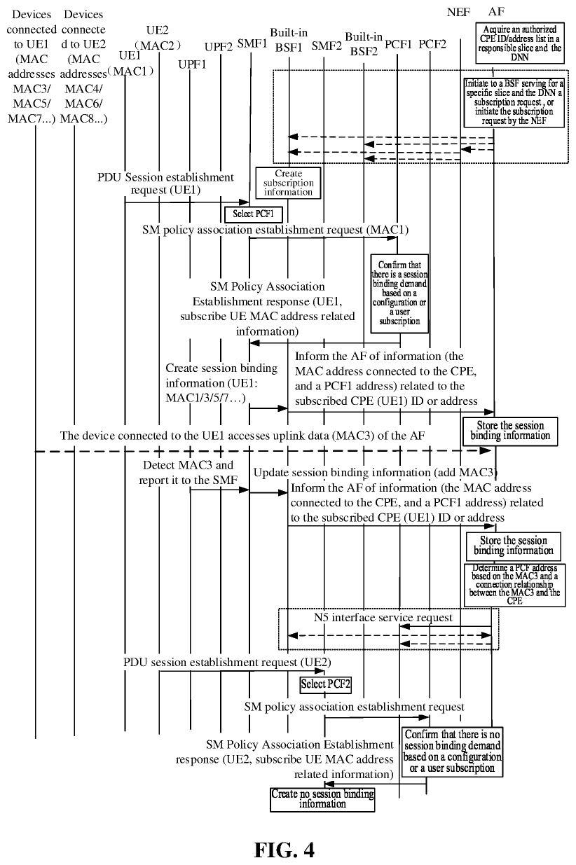

The above embodiment is not limited to the case where the address of the device connected to the CPE is an MAC address, but is also applicable to the case where the address of the device is an IP address. In another implementation example of the present disclosure, as illustrated in FIG. 4, in the scenario of a non-independent BSF, the procedure of obtaining the MAC address of the device connected to the UE through that the UE carries the MAC address and the UPF performs detection includes following.

The AF acquires an authorized CPE ID/address list in a responsible slice and the DNN.

The AF initiates a subscription request (carrying the slice, the DNN, the CPE ID or the address list) to a built-in BSF (including a BSF1 and a BSF2) serving for a specific slice and DNN. The subscription request may also be initiated to the built-in BSF (including the BSF1 and the BSF2) by the NEF.

UE1 initiates a PDU Session establishment request to an SMF1.

The SMF1 sends an SM Policy Association Establishment request to a PCF1.

The PCF1 confirms that there is a session binding demand based on a configuration or a user subscription.

The PCF1 sends an SM Policy Association Establishment response to the SMF1.

The SMF1 creates session information (containing the MAC address carried by a user request) to the BSF1.

The BSF1 informs the AF of information (the MAC address connected to the CPE, or a PCF1 address) associated with the subscribed CPE (UE1) ID or address.

The UPF1 detects the MAC address connected to the CPE and reports same to the SMF1.

The SMF1 updates the binding information (containing the MAC address connected to the CPE detected by the UPF) of the session to the BSF1.

The BSF1 informs the AF of information (the MAC address connected to the CPE, or a PCF1 address) associated with the subscribed CPE (UE1) ID or address.

The AF receives uplink data (MAC3) of the device connected to the UE1 accessing the AF.

The AF determines a PCF address based on the MAC3 and a connection relationship between the MAC3 and the CPE.

The AF/NEF sends N5 interface subscription to the PCF1, or the AF queries the BSF1 for the binding information of the session, and then sends the N5 interface subscription to the PCF1.

UE2 initiates PDU Session establishment to an SMF2.

The SMF2 sends an SM Policy Association Establishment request to a PCF2.

The PCF2 confirms, based on a configuration or a user subscription, that there is no session binding demand.

The PCF2 sends an SM Policy Association Establishment response to the SMF2.

The UE2 does not subscribe UE MAC address related information.

The embodiment of the present disclosure provides the capability that the AF affects user-plane flow route for the Ethernet PDU session, and can solve the PCF addressing in the Ethernet PDU session binding scenario for the scenario where UE is connected to multiple devices.

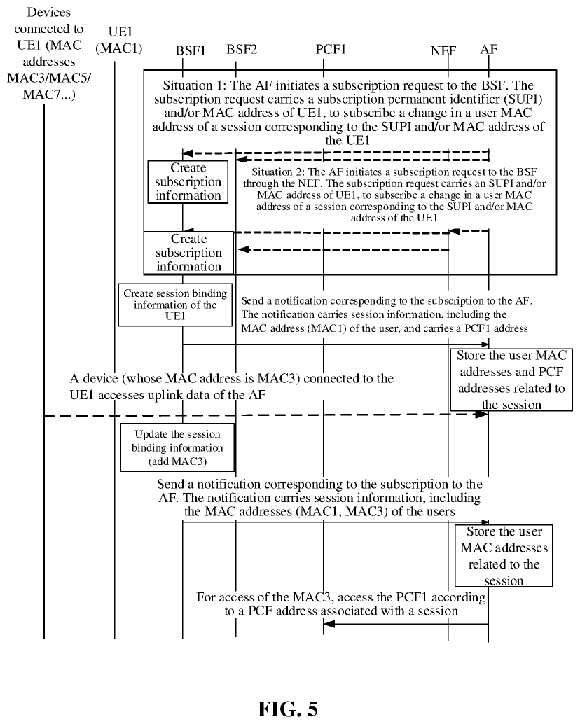

FIG. 5 illustrates an example of another interaction procedure of a method for subscribing session information according to the present disclosure. Operations such as detection of an MAC address in a 5G network are omitted from FIG. 5, and only the time sequence is described illustratively. In FIG. 5, an operation that an AF sends a subscription request to a BSF to subscribe a change in a user address associated with a session of UE1 is prior to an operation that the BSF creates binding information of the session of the UE1. A notification for the subscription contains a PCF address, and a PCF address associated with the session may be obtained through the notification. The procedure mainly includes following.

The AF sends a subscription request to the BSF1 and the BSF2 respectively. The subscription request carries a subscription permanent identifier (SUPI) and/or MAC address of UE1, to subscribe a change in a user MAC address of a session corresponding to the SUPI and/or MAC address of the UE1 (for example, the user address associated with the session changes, a user address is added to the session, or a user address is deleted from the session). The BSF1 and the BSF2 create subscription information respectively.

Subsequently, the SBF1 creates session binding information of the UE1, and thus the BSF1 will send a notification corresponding to the subscription to the AF. The notification carries session information, including the MAC address of the user (MAC1), and may further carry a PCF1 address. In this way, the AF may store the user MAC address (MAC1) and PCF address associated with the session, so as to establish the correspondence relationship between the user MAC address, the session, and the PCF address.

As such, when a device (whose MAC address is assumed to be MAC3) connected to the UE1 accesses uplink data of the AF subsequently, the BSF1 may update the session binding information of the UE1. For example MAC3 is added, and a notification corresponding to the subscription is sent to the AF, the notification carrying the session information, including the MAC addresses of the users (MAC1, and MAC3). The AF may store the user MAC addresses associated with the session. Accordingly, for access of the MAC3, the AF may access the PCF1 according to a PCF address associated with a session subsequently.

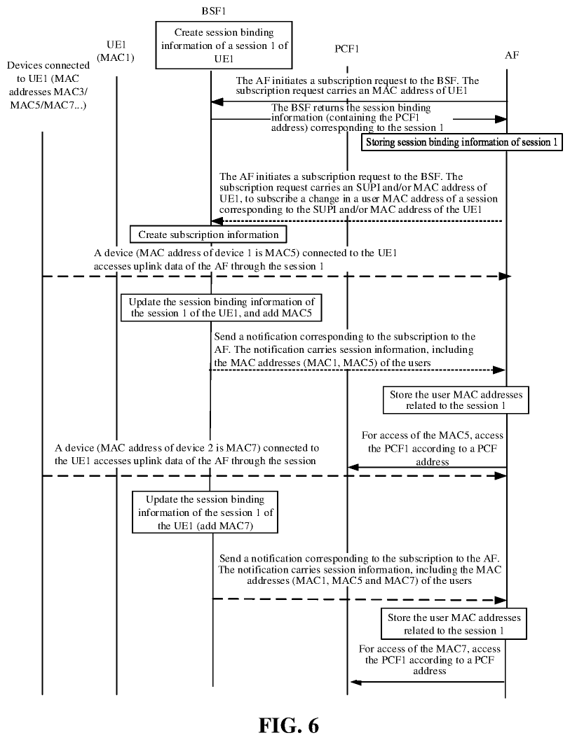

FIG. 6 illustrates an example of another interaction procedure of a method for subscribing session information according to the present disclosure. Operations such as detection of an MAC address in a 5G network are also omitted from FIG. 6, and only the time sequence is described illustratively. In FIG. 6, a BSF creates session binding information of a session of UE1. Subsequently, an AF initiates a session binding information query request for the session. Then the AF subscribes to the BSF for a change in a user address associated with the session (for example, a change in the user address associated with the session, a user address is added to the session, or a user address is deleted from the session). In particular, the PCF address associated with the session may be obtained by querying session related information. The procedure mainly includes following.

The BSF1 creates session binding information of a session 1 of UE1.

The AF initiates a session binding information query of the session 1 to the BSF1, the query carrying the MAC address of the UE1 (MAC1).

The BSF1 returns the session binding information (containing the PCF1 address) corresponding to the session 1 to the AF. The AF stores the session binding information of the session 1, including information such as the PCF1 address associated with the session 1.

The AF initiates a subscription request to the BSF1. The subscription request carries an SUPI and/or MAC address, to subscribe a change in a user MAC address of a session corresponding to the SUPI and/or MAC address of the UE1. The BSF1 creates subscription information.

When a device (whose MAC address is assumed to be MAC5) connected to the UE1 accesses uplink data of the AF through the session 1 subsequently, the BSF1 may update the session binding information of the session 1 of the UE1. For example MAC5 is added, and a notification corresponding to the subscription is sent to the AF, the notification carrying the session information, including the MAC addresses of the users (MAC1, and MAC5). The AF may store the user MAC addresses associated with the session. Accordingly, for access of the MAC5, the AF may access the PCF1 according to a PCF address associated with a session subsequently.

The subsequence procedure that a device (whose MAC address is assumed to be MAC7) connected to the UE1 accesses the uplink data of the AF through the session 1 is also similar, which will not be described here again.

An embodiment of the present disclosure provides a method for subscribing session information, applied to a first network function. The method includes: receiving subscription for the session information from an application function (AF) or a network exposure function (NEF); and sending a notification for the subscription to the AF or the NEF. The notification includes the session information.

The session information is binding information of a session, and includes: a user identifier or a user address; a PCF address or a PCF identifier; a data network name (DNN); and/or a slice identifier.

Optionally, the subscription includes a user identifier or a user address, and the subscription is associated with a session of the user identifier or the user address.

Optionally, the subscription is used for subscribing a situation of: binding information of a session associated with the subscription is created, modified or updated; or the session associated with the subscription is established, or a user address associated with the session is changed, or a user address is added to the session; or a user address is deleted from the session.

Optionally, the session information included in the notification is a user address associated with a session. In particular, the user address is at least one of:
1) a user MAC address;
2) a user IP address; or
3) a user address associated with a session corresponding to the subscription.

Optionally, receiving the subscription for the session information from the AF or the NEF includes subscription for at least one event of: the user address associated with the session changes; a user address is added to the session; or a user address is deleted from the session.

For example, in the case that the subscription is that the user address associated with the session changes, a user address is added to the session, or a user address is deleted from the session, the notification for the subscription may include the user address associated with the session.

Optionally, the session is an Internet protocol (IP) data unit (PDU) session or an Ethernet PDU session, and the user address includes an IP address or a media access control (MAC) address.

Optionally, the subscription further carries a data network name (DNN), a slice identifier, or a PDU session type.

Optionally, the subscription is used for subscribing a situation of: binding information of a session associated with the subscription is created, modified or updated; or the session associated with the subscription is established, or a user address associated with the session is changed, or a user address is added to the session; or a user address is deleted from the session.

Optionally, he notification for the subscription includes at least one of: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address. The binding information of the session further contains a user address associated with the session corresponding to the user identifier or the user address.

It is to be noted that the method embodiment is about a method of a first network function side corresponding to the above method of an application function or a content exposure function side. All implementations of the above method embodiments are applicable to this embodiment, and the same technical effect can be achieved.

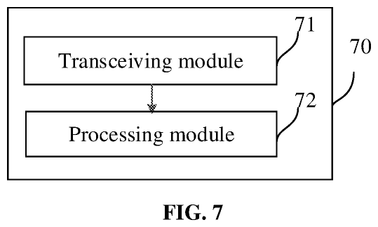

As illustrated in FIG. 7, embodiments of the present disclosure further provide an apparatus 70 for subscribing session information, applied to an application function (AF) or a network exposure function (NEF). The apparatus 70 includes a transceiving module 71. The transceiving module 71 is configured to: subscribe the session information from a first network function; and receive a notification for the subscription and determine a policy control function (PCF). The notification includes the session information.

Optionally, the session information is binding information of a session, and includes: a user identifier or a user address; a PCF address or a PCF identifier; a data network name (DNN); and/or a slice identifier.

Optionally, the subscription includes: a user identifier or a user address, and the subscription is associated with a session of the user identifier or the user address.

Optionally, the subscription is used for subscribing a situation of: binding information of a session associated with the subscription is created, modified or updated; or the session associated with the subscription is established, or a user address associated with the session is changed, or a user address is added to the session; or a user address is deleted from the session.

Optionally, the session information included in the notification is a user address associated with a session.

Optionally, the operation of subscribing the session information from the first network function includes subscribing at least one event of: the user address associated with the session changes; a user address is added to the session; or a user address is deleted from the session.

Optionally, the session is an Internet protocol (IP) data unit (PDU) session or an Ethernet PDU session, and the user address includes an IP address or a media access control (MAC) address.

Optionally, the subscription further includes at least one of: a data network name (DNN), a slice identifier, or a PDU session type.

Optionally, the operation of receiving the notification for the subscription to determine the PCF further includes following operations.

The notification for the subscription is received and according to the notification, at least one of following is obtained: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address. The binding information of the session further contains a user address associated with the session corresponding to the user identifier or the user address.

The PCF is determined according to the user address associated with the session and the binding information of the session, or the first network function is queried to determine the PCF according to the user address associated with the session and the identifier or the address of the first network function.

Optionally, the operation of receiving the notification for the subscription to determine the PCF further includes following operations. The notification for the subscription is received, and at least one of following is further obtained according to the notification: a correspondence relationship between a user identifier or a user address and an identifier or an address of the first network function which creates binding information of a session of a user. The first network function is determined according to the correspondence relationship. The first network function is queried to determine the PCF according to the binding information of the session and a user address associated with the session.

Optionally, the user address is at least one of:
1) a user MAC address;
2) a user IP address; or
3) a user address associated with a session corresponding to the subscription.

Optionally, the operation of receiving the notification for the subscription to determine the PCF includes: receiving the notification for the subscription and obtaining the user address associated with the session according to the notification; and determining the PCF according to the session corresponding to the user address.

Particularly, the session corresponding to the user address may be determined according to the user address, so as to further determine the PCF associated with the session corresponding to the user address.

Optionally, an identifier or address of the PCF is from one of following: a notification for a subscription associated with the session corresponding to the user address; query of information associated with the session corresponding to the user address; storage of the information associated with the session corresponding to the user address; or a configuration of the information associated with the session corresponding to the user address.

Optionally, binding information of a session is created by the first network function, and the PCF indicates, according to a configuration or use subscription data, whether to create the binding information of the session.

Optionally, the PCF indicates, based on at least one of the DNN or slice granularity, whether to create the binding information of the session.

Optionally, the PCF requires a session management function (SMF) to report a user address of a session associated with a DNN and/or a slice, and the binding information of the session contains one or more user addresses associated with the session.

Optionally, the user address includes one of following: a user address carried by user equipment (UE) in a session establishment request or a session modification request of a PDU session; a user address reported by a user plane function (UPF) after the UPF detects a data packet according to a rule issued by the SMF for the PDU session; or a user address reported by a data network authentication, authorization, accounting (DN-AAA) during authentication of the PDU session. The user address is an IP address or an MAC address.

Optionally, the PCF creates or updates the binding information of the session for the first network function after receiving a user address associated with a PDU session that is reported by the SMF; or the SMF creates or updates the binding information of the session for the first network function.

Optionally, before subscribing the session information from the first network function, the method further includes: acquiring an address or address list of a user. The address or address list of the user belongs to at least one of: a predetermined slice, a predetermined DNN, or a predetermined session type.

It is to be noted that, the apparatus corresponds to the above method of an application function or a content exposure function side. All implementations of the above method embodiments are applicable to embodiments of the apparatus, and the same technical effect can be achieved. The apparatus further includes a processing module 72 configured to process information transceived by the transceiving module 71.

Embodiments of the present disclosure further provide an application function (AF) or a network exposure function (NEF), including the above apparatus for subscribing session information.

Embodiments of the present disclosure further provide an apparatus for subscribing session information, applied to a first network function. The apparatus includes a transceiving module. The transceiving module is configured to: receive subscription for the session information from an application function (AF) or a network exposure function (NEF), and send a notification for the subscription to the AF or the NEF. The notification includes the session information.

Optionally, the session information is binding information of a session, and includes: a user identifier or a user address; a PCF address or a PCF identifier; a data network name (DNN); and/or a slice identifier.

Optionally, the subscription includes a user identifier or a user address, and the subscription is associated with a session of the user identifier or the user address.

Optionally, the subscription is used for subscribing following: binding information of a session associated with the subscription is created, modified or updated; or the session associated with the subscription is established, or a user address associated with the session is changed, or a user address is added to the session; or a user address is deleted from the session.

Optionally, the session information included in the notification is a user address associated with a session.

Optionally, receiving the subscription for the session information from the AF or the NEF includes subscription for at least one event of: the user address associated with the session changes; a user address is added to the session; or a user address is deleted from the session.

Optionally, the session is an Internet protocol (IP) data unit (PDU) session or an Ethernet PDU session, and the user address includes an IP address or a media access control (MAC) address.

Optionally, the subscription further carries a data network name (DNN), a slice identifier, or a PDU session type.

Optionally, the notification for the subscription includes at least one of: a PCF identifier or a PCF address associated with a session corresponding to a user identifier or a user address; an identifier or an address of the first network function which creates binding information of a session of a user; or the binding information of the session containing: a user identifier or a user address; and a PCF identifier or a PCF address. The binding information of the session further contains a user address associated with the session corresponding to the user identifier or the user address.

Optionally, the user address is at least one of: a user MAC address; a user IP address; or a user address associated with a session corresponding to the subscription.

It is to be noted that, the apparatus corresponds to the above method of a first network function side. All implementations of the above method embodiments are applicable to embodiments of the apparatus, and the same technical effect can be achieved.

Embodiments of the present disclosure further provide a first network function entity, including the above apparatus for subscribing session information. All implementations of the above embodiment are applicable to this embodiments, and the same technical effect can be achieved.

Embodiments of the present disclosure further provide a communication device, including a processor, and a memory having stored thereon a computer program that, when run by the processor, implements the above method. All implementations in the above method embodiments are applicable to this embodiment, and the same technical effect can be achieved.

Embodiments of the present disclosure further provide a computer-readable storage medium including instruction that, when running on a computer, enables the computer to implement the above method. All implementations in the above method embodiments are applicable to this embodiment, and the same technical effect can be achieved.

Those of ordinary skill in the art may realize that the units and algorithm steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be construed as extending beyond the scope of the present disclosure

Those skilled in the art may clearly appreciate that for convenience and simplicity of description, the particular operation procedures of the system, apparatus and units described above may refer to corresponding procedures in the foregoing method embodiment, which will not be described herein again.

In the embodiments provided in the present disclosure, it is to be understood that the disclosed device and method may be implemented in other ways. For example, the device embodiment described above is only exemplary, and for example, division of the units is only division in logic functions, and division may be made in other ways during practical implementation. For example, multiple units or components may be combined or integrated into another system, or some features may be neglected or not executed. In addition, coupling or direct coupling or communication connection between various displayed or discussed components may be indirect coupling or communication connection, implemented through some interfaces, devices or units, and may be electrical and mechanical or in other forms.

The units described as separate components may or may not be physically discrete from one another. Components displayed as units may or may not be physical units, and can be located at the same place or may be distributed to multiple network units. Some or all of the units may be chosen to realize the purpose of the solution of the embodiments according to actual requirements.

Furthermore, various functional units in the embodiments of the present disclosure may be integrated in one processing unit, or may exist separately physically; or two or more units may be integrated in one unit.

If implemented in form of software functional units and sold or used as independent product, the functions may be stored in a computer-readable storage medium. Based on such understanding, the technical solution of the present disclosure substantially or in part making contributions to the related art or a part of the technical solution may be embodied in a software product. The computer software product is stored in a storage medium, and includes several instructions to enable a computer device (which may be a personal computer, a server, a network device or the like) to perform all or some steps of the method according to various embodiments of the present disclosure. The foregoing storage medium includes various media capable of storage program codes such as a USB flash drive, a mobile hard disk drive, a read-only memory (ROM), a random access memory (RAM), a magnetic disc, or a compact disc (CD).

In addition, it needs to be pointed out that, various components or steps in the apparatus and method of the present disclosure may be decomposed and/or recombined. These decomposing and/or recombination shall be deemed as equivalents of the present disclosure. Moreover, steps performing the series of processing above may be implemented chronologically naturally according to the sequence described, but may not be implemented chronologically necessarily. Some steps may be performed in parallel or independent from one another. Those of ordinary skill in the art may understand that all or any steps or components of the method and apparatus of the present disclosure may be implemented in form of hardware, firmware, software or a combination thereof in any computing device (including a processing, a storage medium, etc.) or a network of computing devices, which may be realized by those of ordinary skill in the art reading the description of the present disclosure using their basic programming skills.

Therefore, the purpose of the present disclosure may also be realized by running a program or a set of programs on any computing device. The computing device may be a common general device. Therefore, the purpose of the present disclosure may also be realized merely by providing a program product containing program codes implementing the method or apparatus. That is to say, such a program product also constitutes the present disclosure, and a storage medium having stored thereon such a program product also constitutes the present disclosure. Apparently, the storage medium may be any common storage medium or any future developed storage medium. It also needs to be pointed out that, various components or steps in the apparatus and method of the present disclosure may be decomposed and/or recombined. These decomposing and/or recombination shall be deemed as equivalents of the present disclosure. Moreover, steps performing the series of processing above may be implemented chronologically naturally according to the sequence described, but may not be implemented chronologically necessarily. Some steps may be performed in parallel or independent from one another.

The above are preferred implementations of the present disclosure. It should be noted that those of ordinary skill in the art may make several improvements and polish without departing from the principle of the present disclosure, which should also be considered within the scope of protection of the present disclosure.

1. A method for subscribing session information, applied to an application function (AF) or a network exposure function (NEF), and comprising:
subscribing the session information from a first network function; and
receiving a notification for the subscription to determine a policy control function (PCF), wherein the notification comprises the session information.

2. The method for subscribing the session information of claim 1,
wherein the session information is binding information associated with a session, and comprises at least one of:
a user identifier or a user address;
a PCF address or a PCF identifier;
a data network name (DNN); and/or
a slice identifier.

3. The method for subscribing the session information of claim 1, wherein the subscription comprises a user identifier or a user address, and the subscription is associated with a session of the user identifier or the user address.

4. The method for subscribing the session information of claim 1, wherein the subscription is used for subscribing a situation of:
binding information of a session associated with the subscription is created, modified or updated; or
the session associated with the subscription is established, or a user address associated with the session is changed, or a user address is added to the session; or
a user address is deleted from the session.

5. The method for subscribing the session information of claim 1, wherein the session information comprised in the notification is a user address associated with a session, wherein subscribing the session information from the first network function comprises subscribing at least one event of:
the user address associated with the session changes;
a user address is added to the session; or
a user address is deleted from the session.

6. (canceled)

7. The method for subscribing the session information of claim 2, wherein the session is an Internet Protocol (IP) data unit (PDU) session or an Ethernet PDU session, and the user address comprises an IP address or a media access control (MAC) address.

8. The method for subscribing the session information of claim 1, wherein the subscription further comprises at least one of: a data network name (DNN), a slice identifier, or a PDU session type.

9. The method for subscribing the session information of claim 1, wherein receiving the notification for the subscription to determine the PCF further comprises:
receiving the notification for the subscription and according to the notification, obtaining at least one of:
a PCF identifier or a PCF address associated with a session corresponding to a user identifier or a user address;
an identifier or an address of the first network function which creates binding information of a session of a user; or
the binding information of the session containing: a user identifier or a user address; and a PCF identifier or a PCF address, wherein the binding information of the session further contains a user address associated with the session corresponding to the user identifier or the user address; and
determining the PCF according to the user address associated with the session and the binding information of the session, or querying the first network function to determine the PCF according to the user address associated with the session and the identifier or the address of the first network function,
or wherein receiving the notification for the subscription to determine the PCF further comprises:
receiving the notification for the subscription and according to the notification, further obtaining at least one of:
a correspondence relationship between: a user identifier or a user address and an identifier or an address of the first network function which creates binding information of a session of a user; or
determining the first network function according to the correspondence relationship; and
querying the first network function to determine the PCF according to the binding information of the session and a user address associated with the session.

10. (canceled)

11. The method for subscribing the session information of claim 5, wherein the user address is at least one of:
a user Media Access Control (MAC) address;
a user Internet Protocol (IP) address; or
a user address associated with a session corresponding to the subscription, wherein receiving the notification for the subscription to determine the PCF comprises:
receiving the notification for the subscription and obtaining the user address associated with the session according to the notification; and
determining the PCF according to the session corresponding to the user address, wherein an identifier or address of the PCF is from one of:
a notification for a subscription associated with the session corresponding to the user address;
query of information associated with the session corresponding to the user address;
storage of the information associated with the session corresponding to the user address; or
a configuration of the information associated with the session corresponding to the user address.

12.-13. (canceled)

14. The method for subscribing the session information of claim 1, wherein binding information of a session is created by the first network function, and the PCF indicates, according to a configuration or use subscription data, whether to create the binding information of the session, wherein the PCF indicates, based on at least one of a data network name (DNN) or slice granularity, whether to create the binding information of the session.

15. (canceled)

16. The method for subscribing the session information of claim 9, wherein the PCF requires a session management function (SMF) to report a user address of a session associated with at least one of a data network name (DNN) and/or a slice, and the binding information of the session contains one or more user addresses associated with the session.

17. The method for subscribing the session information of claim 11, wherein the user address comprises one of:
a user address carried by user equipment (UE) in a session establishment request or a session modification request of a PDU session;
a user address reported by a user plane function (UPF) after the UPF detects a data packet according to a rule, which is issued by an SMF for the PDU session; or
a user address returned by a data network authentication, authorization, accounting (DN-AAA) during authentication of the PDU session;
wherein the user address is an IP address or an MAC address.

18. The method for subscribing the session information of claim 14, wherein
the PCF creates or updates the binding information of the session for the first network function after receiving a user address associated with a PDU session that is reported by an SMF; or
the SMF creates or updates the binding information of the session for the first network function.

19. The method for subscribing the session information of claim 1, wherein before subscribing the session information from the first network function, the method further comprises:
acquiring an address or address list of a user, wherein the address or address list of the user belongs to at least one of: a predetermined slice, a predetermined an MAC address, or a predetermined session type.

20. A method for subscribing session information, applied to a first network function, and comprising:
receiving, from an application function (AF) or a network exposure function (NEF), subscription for the session information; and
sending a notification for the subscription to the AF or the NEF, wherein the notification comprises the session information.

21. The method for subscribing the session information of claim 20, wherein the session information is binding information of a session, and comprises at least one of:
a user identifier or a user address;
a policy control function (PCF) address or a PCF identifier;
a data network name (DNN); and/or
a slice identifier.

22. The method for subscribing the session information of claim 20, wherein the subscription comprises a user identifier or a user address, and the subscription is associated with a session of the user identifier or the user address,
or wherein the subscription is used for subscribing a situation of:
binding information of a session associated with the subscription is created, modified or updated; or
the session associated with the subscription is established, or a user address associated with the session is changed, or a user address is added to the session; or
a user address is deleted from the session.

23. (canceled)

24. The method for subscribing the session information of claim 20, wherein the session information comprised in the notification is a user address associated with a session, wherein:
receiving, from the AF or the NEF, the subscription for the session information comprises subscription for at least one event of:
the user address associated with the session changes;
a user address is added to the session; or
a user address is deleted from the session,
wherein the session is an Internet protocol (IP) data unit (PDU) session or an Ethernet PDU session, and the user address comprises an IP address or a media access control (MAC) address,
wherein the user address is at least one of:
a user Media Access Control (MAC) address;
a user Internet Protocol (IP) address; or
a user address associated with a session corresponding to the subscription.

25.-26. (canceled)

27. The method for subscribing the session information of claim 20, wherein the subscription further carries a data network name (DNN), a slice identifier, or a PDU session type,
or wherein the notification for the subscription comprises at least one of:
a PCF identifier or a PCF address associated with a session corresponding to a user identifier or a user address;
an identifier or an address of the first network function which creates binding information of a session of a user; or
the binding information of the session containing: a user identifier or a user address; and
a PCF identifier or a PCF address, wherein the binding information of the session further contains a user address associated with the session corresponding to the user identifier or the user address.

28.-29. (canceled)

30. An apparatus for subscribing session information, applied to an application function (AF) or a network exposure function (NEF), and comprising:
a transceiving module, configured to: subscribe the session information from a first network function; and receive a notification for the subscription to determine a policy control function (PCF), wherein the notification comprises the session information.

31.-35. (canceled)
